(19) United States
(12) Patent Application Publication
(10) Pub. No.: US 2021/0138970 A1
(43) Pub. Date: May 13, 2021

(54) SYSTEM AND METHOD FOR COMPUTING DEVICE SECURING APPARATUS

(71) Applicant: Racheal Walker, Memphis, TN (US)

(72) Inventor: Racheal Walker, Memphis, TN (US)

(21) Appl. No.: 17/091,538

(22) Filed: Nov. 6, 2020

Related U.S. Application Data
(60) Provisional application No. 62/932,435, filed on Nov. 7, 2019.

(51) Int. Cl. B60R 11/02; F16M 13/02; F16B 47/00

(52) U.S. Cl. CPC B60R 11/0241; F16M 13/022; B60R 2011/0071; F16M 2200/04; F16M 2200/06; F16B 47/006

(57) ABSTRACT

A system and method for a securing device offering a holder that is able to hold a computing device that includes an accessory attached to the back of the computing device whereby the holder has an aperture that enables the rear attached accessory to extend through the aperture of the securing device while the attached computing device is also held by the securing device whereby the secured device is securable to a surface such that the user may easily access the computing device.

### CROSS REFERENCE TO RELATED APPLICATIONS

This application is a non-provisional application which claims priority to U.S. Provisional Application No. 62/932,435 filed on Nov. 7, 2019, which is incorporated by reference in its entirety.

### FIELD OF DISCLOSURE

The field of disclosure is generally directed to a securing apparatus for computing devices, such as a wireless phone, and more particularly, a system and method for an apparatus that accommodates computing devices of varying sizes as well as attached accessories and secures the computing devices while affixed to a surface.

### BACKGROUND

Cell phones have become a mainstay in everyday life as much as wallets and keys. Cell phones have become more versatile than ever, such that they are now replacing computers and cameras, and global positioning systems (GPS). Many protective cases and apparatuses have been developed to protect the devices with some of the cases combining protection capability with the securement of the cell phone to a fixed surface so the cell phone may be propped up and viewable to the user. However, these prior art apparatuses are not designed to accommodate phones of different sizes as well as various accessories such as the Pop Socket™ which is a type of accessory that may be attached to the back of a cell phone. This leads to difficulty for a person to remove the phone from its respective protective case and to secure the accessory to the cellphone. Some of these types of accessories also cannot be removed easily, making them not suitable for the ever changing and erratic lifestyle of many people, which necessitate convenience and safety for a user such as a driver who is relying on the cell phone for navigation. The present invention provides an attachable apparatus that may overcome these and other deficiencies of existing devices.

### SUMMARY

The present invention is directed to a computing device securing system having a top component, a bottom component, and a cradle, the cradle connecting to the top component and the bottom component, wherein the top component and the bottom component including an aperture that is integrally formed therein, wherein the aperture is configured to accommodate an accessory connected to a rear surface of a computing device, the computing device securing system securable to a surface, wherein the cradle has one or more rods and one more tension springs, the cradle of sufficient tension wherein when a computing device is positioned in between the top component and the bottom component, the cradle positioned so that the computing device is secured between the top component and the bottom component, the cradle connected to a jaws, the jaws having a first arm and a second arm, the second arm at an angle to the first arm, the first arm connected to the top component, the second arm connected to the bottom component, the jaws providing structural support when the cradle is extended or relaxed, the first arm and the second arm angled to form a hinge, the hinge permits rotational movement of jaws with respect to a joint arm, wherein the hinge is ball and socket mechanism, the joint arm connected to a base, the base attachable to the surface, the base having a suction mechanism for securing the base to the surface, the suction mechanism connected to a lever, the lever configured to secure and release the suction mechanism, the top component and the bottom component each having a backplate to support and secure the computing device when positioned in the computing device securing system, the bottom component having a bottom wall with protrusions configured to retain bottom edges of the computing device when positioned in the computing device securing system, the bottom wall having an aperture configured to allow access to ports on the computing device, and the top component having a lipped portion configured to retain top edges of the computing device when positioned in the computing device securing system.

The present invention also directed to a computing device securing system comprising a top component, the top component having a top wall with protrusions configured to retain top edges of a computing device when positioned in the computing device securing system, a bottom component, the bottom component having a bottom wall with protrusions configured to retain bottom edges of the computing device when positioned in the computing device securing system, a cradle, the cradle connecting to the top component and the bottom component, wherein the top component and the bottom component including an aperture that is integrally formed therein, wherein the aperture is configured to accommodate an accessory connected to a rear surface of the computing device, the computing device securing system securable to a surface, the top component and the bottom component each having a backplate to support and secure the computing device when positioned in the computing device securing system, wherein the cradle has one or more rods and one more tension springs, the cradle of sufficient tension wherein when a computing device is positioned in between the top component and the bottom component the cradle is positioned so that the computing device is secured between the top component and the bottom component, further comprising: a first arm, the first arm pivotably connected to the cradle and a second arm, pivotably connected to the first arm, the first arm connected to the second arm by a ball and socket mechanism, the second arm connected to a base, the base attachable to the surface, the base having a suction mechanism for securing the base to the surface, the suction mechanism connected to a lever, the lever configured to secure and release the suction mechanism.

### BRIEF DESCRIPTION OF DRAWINGS

The present invention will be described by way of exemplary embodiments, but not limitations, illustrated in the accompanying drawings in which like references denote similar elements, and in which:

FIG. 1 is a front perspective view of an exemplary device securing apparatus as connected to a front windshield of a vehicle.

FIG. 2 is a rear perspective view of the device securing apparatus of FIG. 1.

FIG. 3 is a rear perspective view of the device securing apparatus of FIG. 1 with a phone secured within the device securing apparatus.

FIG. 4 is a side view of the device securing apparatus with a phone secured within the device securing apparatus.

FIG. 5 illustrates a second embodiment of the securing device apparatus.

### DETAILED DESCRIPTION

In the Summary above and in this Detailed Description, and the claims below, and in the accompanying drawings, reference is made to particular features (including method steps) of the invention. The term “comprises,” and grammatical equivalents thereof are used herein to mean that other components, ingredients, steps, among others, are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and upper limit is the second number. For example, 25 to 100 mm means a range whose lower limit is 25 mm and upper limit is 100 mm.

Certain terminology and derivations thereof may be used in the following description for convenience in reference only and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

The present disclosure is generally drawn to a system and method, according to one or more exemplary embodiments, for securing a computing device such as a cell phone into a securing apparatus that is also capable of securing one or more accessories such as Pop Socket™ on the rear surface of the cell phone. This securing apparatus uses a spring loaded phone cradle to adapt and conform to cell phone sizes of different shapes and dimensions, as well as an adjustable ball joint which allows for omnidirectional degree rotation, while also being able to tighten and lock the securing apparatus in any specific orientation. The exemplary securing apparatus, in one or more embodiments, further includes an arm connected to a suction cup housing that offers an additional adjustable angle by thumbscrew and a suction cup having an additional clamp to increase the suction for a prolonged life.

FIG. 1 illustrates one embodiment of a securing apparatus used for a portable electronic device, referred to as securing apparatus 100. Securing apparatus 100 includes a cradle such as cradle 110, jaws such as jaws 150, a joint arm such as joint arm 160, and a base such as base 170. Cradle 110 may have a bottom component such as bottom component 120, a top component such as top component 130, and an adjusting mechanism such as adjusting mechanism 140 joining top component 130 to the bottom component 120. Cradle 110 may include housing sized to receive and retain a computing device, such as an iPhone®, Google Pixel®, and Samsung Galaxy®, or any other type of computing device. The size of Cradle 110 may vary depending on the size of the portable electronic device used within cradle 110. In one or more embodiments, cradle 110 may be connected to a variety of other types of electronic devices including, but not limited to, a video game console, wearable devices, tablets, mp3 players, music players, or a personal computer.

Bottom component 120 may be of a size and shape to fit under the base of the computing device. Bottom component 120 may include a bottom wall such as bottom wall 122, which has an inner and outer surface. Bottom wall 122 may include two rectangular surfaces, the rectangular surfaces having a space between them. The rectangular surfaces may have one or more apertures, such as apertures 133, to prevent obstruction of any features of an intended portable electronic device, such as a charging port, a headphone port, a microphone, or speaker built into the portable electronic device.

Bottom wall 122 may include substantially right angled protrusions such as protrusions 126 and 128. Protrusions 126 and 128 may preferably be triangular in shape. However, this is non-limiting and protrusions 126 and 128 may be rectangular, square, octagonal, hexagonal, or any other shape. Protrusions 126 and 128 point in an upwards direction from bottom wall 122 to further retain the edges of the computing device. Bottom component 120 may have a backing piece such as backing piece 124 having an inner and outer surface to support and secure the computing device. When positioned inside securing apparatus 100, the bottom of a computing device may rest upon bottom wall 122, the lower area of the back of the computing device may rest against backing piece 124, and the front surface of the computing device may be in secured contact with protrusions 126 and 128. Additionally, protrusions 126 and 128 may extend over the lower area of the front surface of the computing device.

Bottom wall 122, backing plate 124, and protrusions 126 and 128 may have one or more gripping surfaces, whereby the gripping surfaces are made of any material or any adhesive whereby the material prevents slippage between securing apparatus 100 and the computing device. The coverage area of the material may be an externally applied adhesive coating or the material may be impregnated within bottom wall 122, backing plate 124, and protrusions 126 and 128 themselves. Alternatively, any type of gripping surface as known in the art may be used on bottom wall 122, backing plate 124, and protrusions 126 and 128.

Top component 130 may be of size and shape to fit over the top of the computing device. Top component 130 may include a top wall such as top wall 132 having an inner and outer surface. Top wall 132 may be comprised of a rectangular surfaces. The rectangular surfaces may have one or more apertures to prevent obstruction of any features, such as a headphone port, microphone, or speaker built into the portable electronic device.

Top wall 132 may include a substantially right angled top lip such as top lip 136. Top lip 136 is preferably an elongated oval in shape. However, this is non-limiting and top lip 136 may be triangular, rectangular, square, octagonal, hexagonal, or any other shape. Top lip 136 points in a downward direction from top wall 132 to further retain the edges of the computing device. Top component 130 may have a backing piece such as backing piece 134 having an inner and outer surface used to support and secure the computing device. When positioned inside securing apparatus 100, the top of the computing device rests upon top wall 132, the upper area of the back of computing device rests against backing piece 134, and the front surface of computing device is in secured contact with top lip 136, whereby top lip 136 extends over the front surface of the upper area of the computing device.

Top wall 132, backing plate 134, and top lip 136 may have one or more gripping surfaces, whereby the gripping surfaces are made of any material or any adhesive whereby the material prevents slippage between securing apparatus 100 and the computing device. The coverage area of the material may be an externally applied adhesive coating or the material may be impregnated within top wall 132, backing plate 134, and top lip 136 itself. Alternatively, any type of gripping surface may be used for top lip 136, top wall 132, and backing plate 134.

In one non-limiting embodiment, backing plates 124 and 134 may have a “U” shaped design. An aperture, such as aperture 114, is included in securing device 100, whereby aperture 114 is located between and contained by backing plates 124 and 134. In one embodiment, backing plates 124 and 134 meet together with aperture 114 located in between backing plates 124 and 134. In some embodiments, aperture 114 may be integrally formed although other manufacturing techniques and methods of forming aperture 114 may be used as well. Aperture 114 is configured to allow for other accessories or apparatuses connected to the rear surface of computing device to remain on the computing device even while the computing device is secured within the backing plate 124 and 134 of securing apparatus 100. Backing plates 124 and 134 may have one or more slots functioning as receiving components for adjusting mechanism 140 whereby adjusting mechanism 140 may be inserted in between top component 130 and bottom component 120. In other embodiments, backing plate 124 and 134 may be affixed to the adjusting mechanism 140 with, for example, fasteners, adhesive, latches, hinges, welding techniques, or any other method known to those skilled in the art whereby the adjusting mechanism may still provide the necessary pressure against computing device.

In one non-limiting embodiment, adjusting mechanism 140 may be a spring based mechanism comprised of a first rod and second rod such as first rod 142 and second rod 144 as shown in FIG. 1. First rod 142 and second rod 144 may be received in slots of backing plates 124 and 134 whereby they may be fully or almost fully enclosed inside top component 130 and bottom component 120 when securing apparatus 100 is at a resting or otherwise inactive state. First rod 142 and second rod 144 may then be fitted with a special gasket. Alternatively, first rod 142 and second rod 144 may be crimped slightly on one end to prevent the first rod 142 and second rod 144 from being completely removed from the inside of backing plates 124 and 134. First rod 142 and second rod 144 may have one or more high-tension springs affixed to first rod 142 and second rod 144 and to an interior surface of backing plates 124 and 134. The springs are adjustable structures that allow for the adjustment of one or more dimensions of the securing apparatus 100.

The springs are formed such when a pulling force may be applied to either top component 130 or bottom component 120, the springs expand in a direction that is parallel to the first rod 142 and second 144. When the pulling force is removed from top component 130 or bottom component 120, the springs will attempt to return to its relaxed shape. As the springs return to their relaxed shape, top component 130 and bottom component 120 meet resistance from computing device preventing further relaxation of the spring. The contracting force remaining within the springs causes top component 130 and bottom component 120 to press against the computing device that is positioned between top component 130 and bottom component 120 thereby holding the computing device in position, as shown for example in FIGS. 3 and 4. To remove the computing device, a pulling force may be applied to either top component 130 or bottom component 120, expanding the springs once again in a direction that is parallel to the first rod 142 and second rod 144 whereby the computing device may be removed. When the pulling force is removed from top component 130 or bottom component 120, the springs will attempt to return to their relaxed shape

Those of ordinary skill in the art will appreciate that the adjusting mechanism may include any number of shapes and sizes for the rods in various configurations and is not limited to those depicted in the Figures or described above.

In some non-limiting embodiments, adjusting mechanism 140 may instead be a latch mechanism comprised of a push button mechanism operable in relation to an extension body (not shown) whereby the push button locking device is used to selectively alter the length of the extension body, thereby adjusting the height of the cradle 110 to accommodate for the varying distances between the bottom and top surfaces of the computing device.

The extension body is comprised of a left and right segment positioned symmetrically around the vertical axis of the system. Each segment has an outer component and inner component. In each segment are aligned holes formed in the outer component and are of a certain distance from one another. In each segment a push button mechanism may be positioned within the inner component so as to protrude through the left and right series of aligned holes formed in the outer component and through a hole formed in the inner component. The push button mechanism is provided with a button, fixed to a spring clip, or any variation thereof. The clip is preferably formed of a resilient metal strip bent over on itself and having a distal side which, when compressed within the inner component, exerts an outward force on the button. This outward force maintains the push button mechanism in an engaged position within the inner component with the buttons extending through the holes in the inner component and the series of aligned holes of the outer component. In some embodiments, the ends of the inner component and outer component may be designed to prevent complete displacement of the inner component from the outer component or have a method or system such as a gasket, crimping, or any other known methods or systems to those of ordinary skill in the art to prevent complete displacement of the inner component from the outer component.

With the latch mechanism in the present invention, the user may adjust the height of securing apparatus 100 to accommodate for varying distances of computing devices. Depressing the buttons of the push button mechanism releases the latch mechanisms into a disengaged position whereby the outer component of the extension body may freely move relative to the inner component in a linear telescopic motion. The upward motion of the outer component relative to the inner component lengthens the extension body of the system whilst a downward motion of the outer component relative to the inner component shortens the extension body. Once the depressing force is terminated, the expansive force of the push button mechanism causes the button to protrude out of the first of the aligned holes with which it comes into alignment, preventing any further movement.

In further non-limiting embodiments, the push button mechanism may only be fixed to one segment whilst the second segment is held in position by the push button mechanism on the first segment. In further embodiments, the system may be comprised of only two components including a top platform or bottom platform having the inner component of the extension body built into it and the other platform having the outer component of the extension tube. In this embodiment, when the button is depressed the push button mechanism releases the latch mechanisms into a disengaged position whereby the outer component of the extension body may freely move relative to the inner component in a linear telescopic motion. In further embodiments, the system may only have one latch system in the middle of the system connecting the top and bottom platform. Those of ordinary skill in the art will appreciate that the latch mechanism may include any number of buttons and holes in various configurations and is not limited to the number depicted in the attached illustrations or described above.

Cradle 110 may be connected to jaws 150 to provide structural support when cradle 110 is extended or relaxed as well as connects cradle 110 to the other components of securing apparatus 100 as illustrated in FIG. 2. Jaws 150 may include a first arm such as arm 152 that may be attached to the rear surface of a backing plate, such as being fastened to backing plate 134. A second arm of jaws 150, such as arm 154, may be attached to the rear surface of backing plate 124, whereby arm 152 and 154 are at angle in relation from one another. Arms 152 and 154 of jaws 150 may be angled in such a way that they come together, forming a hinge, whereby the hinge permits rotational movement of jaws 150 with respect to joint arm 160. In one non-limiting embodiment, arms 152 and 154 of jaws 150 may be designed so that rotational movement may be stopped after reaching a specific angle. Arm 152 and arm 154 are located at different elevations whereby arms 152 and arms 154 are at an angle in relation to one another whereby when a pulling force is applied to top component 130 or bottom component 120, the angle between arms 152 and arms 154 increases. When the pulling force is no longer applied to top component 130 or bottom component 120, the angle between arms 152 and arms 154 decreases, returning jaws 150 to its original state or position.

In one non-limiting embodiment, jaws 150 may be connected to joint arm 160 by a ball and socket mechanism, such as ball and socket mechanism 162 shown in FIGS. 2-3. In one embodiment, ball and socket mechanism 162 may be comprised of a ball and socket connection, whereby ball and socket mechanism 162 may be positioned at different angles and configurations thereby adjusting the height and other dimensions of securing apparatus 100 to accommodate for the varying angles of jaws 150. Utilizing ball and socket mechanism 162, jaws 150 is capable of motion around an indefinite number of axes, which have a common center at ball and socket mechanism 162.

Ball and socket connection 162 may have a first end segment and a second end segment. An engaging end surface is present at the first end segment. The second end segment is substantially or completely hollowed out. The surface of the receiving cavity is tailored to fit the engaging end surface. In some non-limiting embodiments, a bulge may protrude from a surface of the receiving cavity to stop the movement of the engaging end surface thus preventing over angulation or separation in the connection. The receiving cavity wall thickness and/or the engaging end surface wall thickness are built whereby an interference fit is present after the ball and socket joint connection is linked. It should be appreciated that the ball and socket mechanism may include any number of shapes, hollow areas, and sizes in various configurations and is not limited to those described above.

Joint arm 160 may have a “U” shaped mounting bracket at the second end of joint arm 160 for connecting to a connecting portion such as connecting portion 172 of base 170, as shown in FIGS. 3-4. The mounting bracket may have a forked head appearance with a first member and second member that extend substantially parallel to the rotation of base 170. The first member and second member may include an aperture extending through the lateral surface of the first and second members, whereby the apertures may be axially aligned with a hole through connecting member. In this embodiment, a fastener (e.g. such as a pivot screw, pulling pin, or other fastener) may be placed through the hole of the first member and second member and the hole in the connecting portion 172 so that the joint arm may be pivotally connected to the connecting member and thus the base 170. When fastened in a pivoting connection, joint arm 160 is rotatable around an axis transverse with respect to the axis of the support leg so that the mounting bracket may be swung to a first position where one side of joint arm 160 comes in contact with base 170 and to a second position whereby the opposite side of joint arm 160 comes in contact with base 170. The mounting bracket may also be orientated at any angle or position located between the first position and second position such as at a 90-degree angle relative to the first position where joint arm 160 is in a vertical orientation perpendicular to base 170 and pointing directly upwards of base 170 is parallel with a surface.

In some embodiments, joint arm 160 may be locked at a specific angle relative to base 170 by a position-locking thumb screw such as thumb screw 166 shown in FIG. 3. Alternatively, other locking mechanisms known by those of ordinary skill in the art may be used whereby joint arm 160 is maintained at a chosen angle relative to base 170. This allows joint arm 160 to be locked at different angles for dissimilar surfaces. The pivoting action of joint arm 160 with respect to base 170 increases the versatility for viewing the computing device at various angles including directly above or below depending on the surface that base 170 is attached to, as illustrated in FIG. 3. In other non-limiting embodiments joint arm 160 may be connected to base 170 using any affixation methods known in the art, including using any type of fasteners, adhesives or via welding or soldering, without limitation to these methods.

Base 170 may include a receptacle such as receptacle 174 and a suction cup such as suction cup 176 as illustrated in FIG. 4. In one non-limiting embodiment, suction cup 176 may be formed by rubber or polyvinyl chloride (PVC) material having a concave suction face and a convex exterior face. Suction cup 176 may be connected to an adjustable lever such as lever 178 on receptacle 174 used to fasten and loosen the grip of suction cup 176. When attaching suction cup 176 to a surface, suction cup 176 is first placed over the surface, and then receptacle 174 is pressed down toward the surface for a firm grip on the holding surface. Next, lever 178 may be cranked in the downward direction, whereby the force created is translated to an upward pulling force on the central portion of suction cup 176 whereby air is drawn out from the enclosed space of suction cup 176 and the air pressure between suction cup 176 and the surface is reduced creating suction force forcing suction cup 176 and the surface to stick together. When removing suction cup 176, lever 178 is pulled upward, so that the central part of the suction cup 176 is depressed, thus releasing suction cup 176 from the holding surface.

The present description includes disclosure for one or more embodiments of a securing device, such as securing device 100, that is useful for holding a computing device that is easily viewable at eye level. Further, the securing device 100, as described in one or more non-limiting embodiments, enables a user to view the computing device while the computing device is securely held within securing device 100 without having to remove any accessories located on the back surface of a cover or rear surface of computing device. As noted above, such accessories are commonly used these days and include accessories such as the PopSocket™.

FIGS. 3 and 4 include an illustration of an accessory that looks like a PopSocket™ such as accessory 400 located on the back of computing device such as computing device 300 illustrated in these Figures. A PopSocket™ is a type of accessory that usually includes a flat circle on one side and has an extendable body. There is usually a sticky surface with a removable adhesive side that enables this accessory to be attached to a surface. Most users stick this stickable side of this accessory to the back of their computing device (as shown in FIGS. 3 and 4). This accessory has various purposes and functions. This accessory enables the user to pull out the body in its extended position so that the cell phone or other computing device can be propped up on a table or other surface and the user can look at the screen of the computing device without holding the device. Further, this accessory is useful because it provides a user with the ability to grip onto the back of the accessory, thus giving the user a better hold of the cell phone or other device if a user is trying to take a selfie or a group picture while holding the cell phone or other device. There are other uses and functions for these accessories. Sometimes people wrap their wired ear cords around them to store the ear cords or earbuds on their phone. In general, such accessories have become very popular lately because they are a tool for better gripping of one's phone or other computing device, particularly when one is trying to take a picture (such as a selfie) and they allow the computing device to be propped at an angle onto a surface.

Accordingly, securing device 100 offers a new and useful type of holder that is able to hold a computing device that includes one of these accessories attached to the back of the computing device. Aperture 114 in securing device 100 is an opening that enables an accessory such as PopSocket™ or any other type of accessory to extend through aperture 114 of securing device 100 while the attached computing device is also held securely within securing device 100. Thus, the user is saved from the trouble of having to remove the accessory every time he or she wants to put their cell phone or other computing device in a holder while they are driving or engaging in some other activity. Beneficially, the user is able to keep their accessory fastened to their computing device while the computing device is held securely in securing device 100 as described herein in one or more non-limiting embodiments.

FIG. 5 illustrates a second embodiment of a securing apparatus used for a mobile electronic device, referred to as securing apparatus 200. Securing apparatus 200 includes a cradle having pivotable hinges such as hinges 210 to secure a computing device instead of an adjusting mechanism. Hinges 210 permit rotational adjustment towards and away from the cradle by upward or downward force upon hinges 210. If adjustment of hinges 210 relative to the cradle is desired to allow the cradle to receive a computing device, it may be accomplished by pressing upward on hinges 210 away from the cradle thereby adjusting hinges 210 whereby hinges 210 extend outward allowing room for the computing device to be placed in the cradle. Hinges 210 may then be rotationally adjusted by downward force back towards the cradle whereby tension then may be produced between hinges 210 and computing device. Hinges 210 provide a downward pressure and upward pressure on computing device securing the computing device in place. In another embodiment, jaws has been replaced by a mounting arm such as mounting arm 220 connected by a ball and socket to a joint arm such as joint arm 230. In further embodiments, there may be only one arm connecting the cradle to a ball and socket connection at the base.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

What is claimed is:

1. A computing device securing system comprising:
a top component;
a bottom component; and
a cradle, the cradle connecting to the top component and the bottom component, wherein the top component and the bottom component including an aperture that is integrally formed therein, wherein the aperture is configured to accommodate an accessory connected to a rear surface of a computing device, the computing device securing system securable to a surface.

2. The computing device securing system of claim 1, wherein the cradle has one or more rods and one more tension springs, the cradle of sufficient tension wherein when a computing device is positioned in between the top component and the bottom component, the cradle is positioned so that the computing device is secured between the top component and the bottom component.

3. The computing device securing system of claim 2, the cradle connected to a jaws, the jaws having a first arm and a second arm, the second arm at an angle to the first arm, the first arm connected to the top component, the second arm connected to the bottom component, the jaws providing structural support when the cradle is extended or relaxed.

4. The computing device securing system of claim 3, the first arm and the second arm angled to form a hinge, the hinge permits rotational movement of the jaws with respect to a joint arm.

5. The computing device securing system of claim 4, wherein the hinge is ball and socket mechanism.

6. The computing device securing system of claim 5, the joint arm connected to a base, the base attachable to the surface, the base having a suction mechanism for securing the base to the surface.

7. The computing device securing system of claim 6, the suction mechanism connected to a lever, the lever configured to secure and release the suction mechanism.

8. The computing device securing system of claim 7, the top component and the bottom component each having a backplate to support and secure the computing device when positioned in the computing device securing system.

9. The computing device securing system of claim 8, the bottom component having a bottom wall with protrusions configured to retain bottom edges of the computing device when positioned in the computing device securing system.

10. The computing device securing system of claim 9, the bottom wall having an aperture configured to allow access to ports on the computing device.

11. The computing device securing system of claim 10, the top component having a lipped portion configured to retain top edges of the computing device when positioned in the computing device securing system.

12. A computing device securing system comprising:
a top component, the top component having a top wall with protrusions configured to retain top edges of a computing device when positioned in the computing device securing system;
a bottom component, the bottom component having a bottom wall with protrusions configured to retain bottom edges of the computing device when positioned in the computing device securing system; and
a cradle, the cradle connecting to the top component and the bottom component, wherein the top component and the bottom component including an aperture that is integrally formed therein, wherein the aperture is configured to accommodate an accessory connected to a rear surface of the computing device, the computing device securing system securable to a surface.

13. The computing device securing system of claim 12, the top component and the bottom component each having a backplate to support and secure the computing device when positioned in the computing device securing system.

14. The computing device securing system of claim 13, wherein the cradle has one or more rods and one more tension springs, the cradle of sufficient tension wherein when a computing device is positioned in between the top component and the bottom component the cradle is positioned so that the computing device is secured between the top component and the bottom component.

15. The computing device securing system of claim 14 further comprising a first arm, the first arm pivotably connected to the cradle.

16. The computing device securing system of claim 15 further comprising a second arm, pivotably connected to the first arm.

17. The computing device securing system of claim 16, the first arm connected to the second arm by a ball and socket mechanism.

18. The computing device securing system of claim 17, the second arm connected to a base, the base attachable to the surface, the base having a suction mechanism for securing the base to the surface.

19. The computing device securing system of claim 18, the suction mechanism connected to a lever, the lever configured to secure and release the suction mechanism.

20. The computing device securing system of claim 12, wherein the cradle has a latch mechanism wherein the latch mechanism is used to selectively alter the length of an extension body, thereby adjusting a height of the cradle to accommodate for varying distances between a bottom surface and a top surface of the computing device.
